(19) United States
(12) Patent Application Publication
(10) Pub. No.: US 2026/0242697 A1
(43) Pub. Date: Aug. 20, 2026

(54) DETERGENT COMPOSITION FOR INTERIOR PARTS OF VEHICLE HAVING A PH COMPRISED BETWEEN 3 AND 5

(71) Applicant: MA-FRA S.P.A., Baranzate (MI) (IT)

(72) Inventor: Marco Mattioli, Baranzate (MI) (IT)

(73) Assignee: MA-FRA S.P.A., Baranzate (MI) (IT)

(21) Appl. No.: 19/469,390

(22) PCT Filed: Mar. 27, 2024
(86) PCT No.: PCT/EP2024/058203

§ 371 Date: Sep. 26, 2025

(30) Foreign Application Priority Data
Mar. 28, 2023 (IT) 102023000005955

(51) Int. Cl. C11D 3/04; C11D 1/62; C11D 1/835; C11D 3/20; C11D 3/34; C11D 3/36

(52) U.S. Cl. CPC C11D 3/042; C11D 1/62; C11D 1/835; C11D 3/2079; C11D 3/2082; C11D 3/2086; C11D 3/34; C11D 3/36; C11D 2111/12; C11D 2111/14; C11D 2111/44

(57) ABSTRACT

An aqueous composition for the cleaning and/or stain removal of the plastic and fabric surfaces of the internal parts of vehicles, i.e. cars, motor vehicles, trucks, buses, lorries, railway carriages and other means of locomotion on rails, both public and private, is described herein. The use of this composition and a complete washing and/or stain removal process which includes the use of such composition is also described.

### TECHNICAL FIELD OF THE INVENTION

The present invention relates to an aqueous composition having a pH comprised between 3 and 5 for the cleaning and/or stain removal of the plastic and fabric surfaces of the interior parts of vehicles, i.e. cars, motor vehicles, trucks, buses, lorries, railway carriages and other means of locomotion on rails, both public and private.

### BACKGROUND OF THE INVENTION

In the market segment concerning the cleaning and care of fabric seats, mats, metal parts and interior plastics of vehicles, such as cars, trucks, lorries, buses and in general vehicles used for public and private transport, including means of locomotion on rails, an immediate identification and subsequent removal of spots hidden or invisible to the human eye is especially relevant, in particular, those stains made up of inorganic residues, such as limestone, minerals, dust, or organic residues, such as sweat and mixed dirt stains, and the use of cleaning products dedicated to this purpose.

Currently, the market for vehicle interior care products is made up of alkaline formulations (pH>7) that do not allow complete cleaning of the passenger compartment and, in particular, the removal of inorganic stains. A very common problem that occurs, when caring for vehicle interiors, it is in fact the presence of inorganic stains treated with alkaline detergents, which become visible once the fabric is dried. When this happens, it is necessary to repeat the treatment, for example of a seat, causing the product to penetrate into the deeper layers of the fabric and thus making the washing and drying phase difficult and consequently lengthening the working times and leaving halos and stains after drying. These residues are dust stains that the alkaline product was unable to remove.

Furthermore, on the plastic supports, the common alkaline detergents, besides not removing inorganic residues, tend to fade the surface and often leave an uneven finish and surface halos. An effective treatment should instead give to the treated fabric a final aspect more pleasing to the eye, an impression of renewal effect of the colour of the fibre and a natural and streak-free surface finish, as well as quick rinsing and subsequent drying of the treated supports.

All the products on the market today are water-based alkaline and it is for this reason that the product, once dried, leaves a light patina, which with time and the layering of the various treatments becomes increasingly evident.

Patent application DE19511193 reports a process for cleaning rugs or carpets, in which the aqueous cleaning liquid used, is characterized in that such cleaning liquid contains an alkali metal salt of a polycarboxylic acid or of a hydroxycarboxylic acid, having from 2 to 12 carbon atoms and in which the weight ratio of this alkali metal salt, calculated as free acid, with respect to any surfactant contained in the cleaning solution, is at least 2:1. The content of alkali metal salts of polycarboxylic acids or hydroxycarboxylic acids in the cleaning liquid is between 0.05 and 10% by weight, preferably between 0.2 and 5% by weight. The detergent liquid used preferably has a pH between about 3 and about 12, in particular, between about 5 and about 9. This detergent composition is therefore a composition to be used for rugs or carpets, which are more resistant and less delicate fabrics than those, which are used for the internal parts of vehicles. This composition is characterized by the presence of alkali metal salts of polycarboxylic acids or hydroxycarboxylic acids, instead of free acids. Furthermore, in this patent application no reference is made to the problem of removing inorganic stains, dust or dirt.

### DESCRIPTION OF THE INVENTION

The object of the present invention is therefore to provide a water-based composition having a pH comprised between 3 and 5, preferably buffered, for the cleaning and care of fabrics and internal plastics of vehicles, which solves the problems mentioned above and at the same time reduces the user's working and drying times. The object of the invention is also the development of a specific treatment procedure for the complete and total cleaning of vehicle interiors.

In general, the present water-based acidic composition includes one or more of the following components in a total amount ranging from 0.01%-0.5% by weight: at least one inorganic acid (for example: phosphoric acid, hydrochloric acid, sulfuric acid), at least one mono-, di- or tri-carboxylic organic acid (for example: acetic acid, citric acid, formic acid, oxalic acid), at least one phosphonic acid (for example: etidronic acid), at least one hydroxyacid (for example: glycolic acid, lactic acid) or at least one sulfonic acid (for example: methanesulfonic acid, sulfamic acid).

According to one aspect of the invention, the present water-based acid composition comprises one or more of the following components: citric acid (CAS: 77-92-9), etidronic acid (CAS: 7414-83-7), glycolic acid (CAS: 79-14-1), lactic acid (CAS: 79-33-4) and phosphoric acid (CAS: 7664-38-2).

The main object of the present invention is therefore an aqueous composition for cleaning and/or removing stains from the fabric and/or plastic surfaces of the interior parts of vehicles comprising citric acid, etidronic acid and/or phosphoric acid and/or glycolic acid (CAS: 79-14-1) and/or lactic acid (CAS: 79-33-4).

According to one aspect of the invention the composition further includes non-ionic surfactants, cationic surfactants, emulsifiers, sequestering agents, colorants and perfume.

The vehicles, the interior parts of which can be treated with the composition of the invention, are selected from among cars, motor vehicles, lorries, buses, trucks, railway carriages and other public and private means of locomotion on rails.

The composition of the invention is particularly suitable for the cleaning and/or removal of inorganic stains by means of both manual and automatic dispensing and washing systems and can be used as a pre-treatment for a complete washing, which comprises a following treatment with alkaline detergent compositions (pH>7).

The use of the composition of the invention results in a visual effect that is not achievable with common alkaline detergents on the market. The organic acidic nature of the active ingredients is in fact extremely compatible with the fibres of the fabric, which, once freed from inorganic residues, are renewed in their colouring.

In fact, immediately after its application on the surface to be treated, the composition acts as a highlighter for spots that are often not very visible to the eye, thus facilitating the user's work and helping for the complete removal. The effect, called “Luminol™ effect”, is produced by the reaction of the active ingredient(s) (the acid compounds) and the co-formulants contained that interact with the dirtiness present on the surfaces, forming a momentary active foam that is immediately perceptible to the eye. This effect of the present composition is illustrated in FIGS. 1 and 2. These stains of inorganic origin are the main cleaning problem linked to the use of common alkaline detergents.

FIGS. 1 and 2 show how the composition of the present invention is able to highlight the part of the surface containing dirt residues.

Specifically, the “Luminol™ effect” occurs through a reaction with mixed inorganic residues deriving from external climatic conditions (e.g. rain), sweat stains or dirt and/or water-based beverages transported inside the vehicle and which incorporate a mixture of powders and salts, such as carbonates, silicates and limestone residues in general.

An example of the reaction between the acid and the inorganic sodium carbonate salt present on the surface to be treated is shown below.

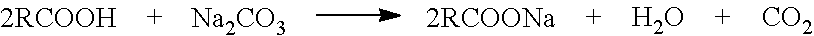

(in which R represents an organic or inorganic group).

The acid reacts slowly with sodium carbonate, thus favouring the constant formation of carbon dioxide, which, together with the co-formulants contained (surfactants and sequestering agents), produces a significant and visible effect to the user (Luminol™ effect).

Specifically, the formation of carbon dioxide that develops from the reaction described above allows the composition to remain on the surface layer of the permeable fabric, favouring an optimal treatment of the stain, a swift and an effective removal of residues and drying. The other products of the reaction are water and water-soluble salts, which are easily removed with a simple damp cloth or a normal household wet vacuum cleaner without the need to use specific and professional equipment. Moreover, it is not necessary to rinse or wash the fabric, thus avoiding waiting long drying times.

The plastic surfaces and supports treated with the composition are similarly renewed in their visual appearance. The resulting finish is authentic and is not altered by the active ingredients contained. Furthermore, no surface residues are observed, which often occur due to excessive use of a detergent product and a failure to identify existing stains with the common marketed detergent compositions.

Furthermore, by using the composition of the invention, any pre-treatment of the single stains before washing is no longer necessary, thus eliminating a processing step. Normally, for one vehicle interior washing cycle, the work time estimated by professional operators is about 3 hours. With the use of this composition, together with the lack of single pre-treatments and rapid drying (consequence of the fact that it will no longer be necessary to repeatedly use the product in order to remove the stain), the working time is halved.

The composition has been tested by professionals in the sector to develop a new complete process for the cleaning and/or stain removal of plastic and fabric surfaces of vehicle interior parts, which is described in detail here below.

Such process comprises the following steps:
dispensing the aqueous detergent composition of the invention having a pH comprised between 3 and 5 on the surface to be treated;
brushing the entire surface, on which the composition was applied;
waiting an average time between 5 and 15 minutes;
optionally, subsequent dispensing an alkaline detergent composition; and
removing the superficial excess with a damp cloth or liquid suction equipment.

An example of the alkaline detergent composition, which can be used subsequent to the acidic composition of the present invention, is #Ductile™.

The method described herein is innovative as there is no similar procedure on the market that leads to complete care and cleaning of the surfaces to be treated (seats, plastics, general passenger compartment interior), which does not require pre-treatment of the single stains and which halves the working time and drying. A cycle is then completed in 1.5 hours instead of 3 hours.

Unless otherwise defined, all technical and scientific terms used here and below have the same meaning as commonly understood by a person with ordinary experience in the art, to which the present invention belongs.

Although methods and materials similar or equivalent to those described herein can be used in the practice and in the tests of the present invention, the methods and materials are described below as an example. The materials, methods and examples are for illustrative purposes only and are not intended to be restrictive.

As used in this specification and in the claims, the terms “comprising”, “containing” or “including” mean that at least the compound, element, material, co-formulant, or the method or the step, etc., indicated are present in the composition, in the formulation, or in the process, even if the presence of other compounds, elements, materials, excipients or steps of the method, etc., is not excluded and even if the other such compounds, elements, materials, excipients, or method, or steps, etc., have the same function as that which is indicated, unless there is an explicit exclusion in the claims. It is also to be understood that the mention of one or more steps of the method does not exclude the presence of further steps of the method before or after the recited combined procedure or intermediate steps of the method among those expressly identified.

### DESCRIPTION OF THE FIGURES

FIG. 1 shows a demonstration sequence highlighting the so called “Luminol™ effect”. The first photo from the left shows a dirty surface (of a fabric car seat) to be cleaned; in the second and third photos the composition of the invention is sprayed on this surface; the fourth photo shows how the composition acts as a highlighter for spots that were hardly visible to the eye before application, that is, in the first photo.

FIG. 2, like FIG. 1, shows a demonstration sequence that highlights the so-called “Luminol™ effect”. The first photo from the left shows a dirty surface (of a seat in a fabric different from that of FIG. 1) to be cleaned; in the second and third photos the composition of the invention is sprayed on this surface; the fourth photo shows how the composition acts as a highlighter for spots that were hardly visible to the eye before application, that is, in the first photo.

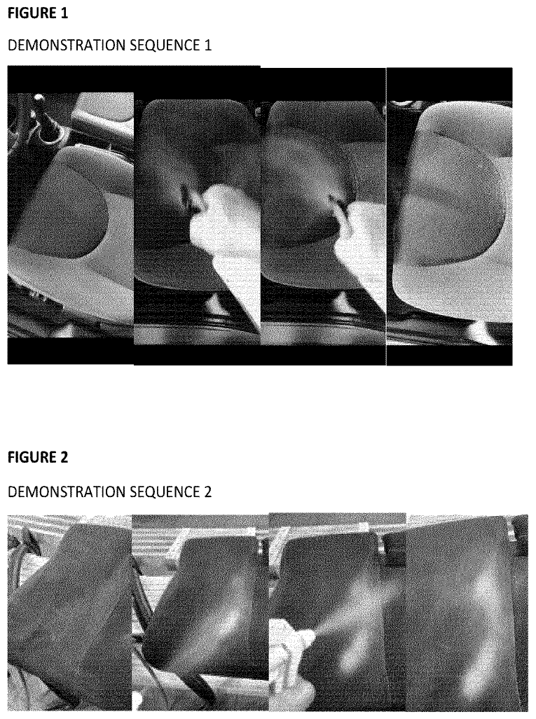

### EXAMPLES

### Example 1—Preparation of the Detergent Composition of the Present Invention Having a pH Comprised Between 3 and 5

The following material were used in the amounts reported below.
Alkyl polyglucosides C₈-C₁₆ 0.1%-4%
[Suppliers: BASF ITALIA S.p.A., BRENNTAG S.p.A.]
Quaternary ethoxylated C₁₂-C₁₄ alkyl methyl amine, methyl chloride 0.1%-3%
[Supplier: Specialities S.r.l.]
Acids which can be used individually or in mixtures
   0.01%-0.5%
      Inorganic acids (e.g. phosphoric acid, hydrochloric acid, sulfuric acid)
      Mono-, di-, tri-carboxylic organic acids (e.g. acetic acid, citric acid, formic acid, oxalic acid)
      Hydroxy acids (e.g. glycolic acid, lactic acid)
      Phosphonic acids (e.g. etidronic acid)
      Sulfonic acids (e.g. methanesulfonic acid, sulphamic acid)
      [Suppliers: BRENNTAG S.p.A., Rainoldi S.p.A., Torchiani S.R.L., Gamma Chimica S.p.A., Connect Chemicals Italia S.r.l., Eurosyn S.p.A.]
Other components or co-formulants: sequestering agent {Glutamic acid, N,N-Diacetic acid, tetrasodium salt [supplied by BRENNTAG S.p.A.], perfume (SEA SHELL [supplied by GRC Parfum S.p.A.]}.

The preparation of the water-based composition occurred by sequential addition of the ingredients respecting the solubilisation times and maintaining a constant stirring (rotor speed at 700 rpm). The only solvent used during preparation was water. Specifically, the active ingredients (the acids and the surfactants) were initially added to the solvent phase (water) and subsequently the co-formulants (other components) listed above were added. The final composition was clear and transparent.

In particular, four compositions with a pH between 3 and 5 were prepared which fall within the invention and whose composition is shown in the Table below.

| | | Etidronic | Phosphoric | Acido |
|---|---|---|---|---|
| | Citric acid | acid | acid (% | glicolico |
| Compositions | (% weight) | (% weight) | weight) | (% weight) |
| Composition A | 0.2 | — | — | — |
| Composition B | 0.05 | 0.1 | — | — |
| Composition C | — | 0.05 | 0.05 | — |
| Composition D | — | 0.015 | — | 0.015 |

### Example 2—Complete Cleaning Process of the Interior Seats of the Passenger Compartment of a Car

The composition B prepared according to Example 1 was used as such (without dilutions), by spraying it onto the surface of a fabric seat of a car to be cleaned and with various stains to be removed. Subsequently, the entire surface, on which the product was applied, was brushed. The product was left to act for about 10 minutes. Subsequently, the alkaline product (#Ductile™) diluted with 10 parts of water was sprayed on the same surface. Finally, the surface excess was removed with equipment that sucks up liquids, for example, traditional dry steam equipment or Mafra Geyser steam/suction units.

The surface turned out to be clean, having a uniform colour and without any stain.

### Example 3—Cleaning Process of the Interior Seats of the Passenger Compartment of a Car by Using Only Composition B

The composition B prepared according to Example 1 was used as such (without dilution), by spraying it on the surface of a fabric seat of a car to be cleaned and with stains to be removed. Subsequently, the entire surface, on which the product was applied, was brushed. The product was left to act for about 10 minutes. Finally, the surface excess was removed with equipment that sucks up liquids, for example, traditional dry steam equipment or Mafra Geyser steam/suction units.

The surface resulted to be clean, having a renewed, uniform colour and without the inorganic stains that were visible before the treatment.

### Comparative Example 1—Cleaning Process of the Interior Seats of a Car Passenger Compartment Only with #Ductile™ (Alkaline Composition, Having pH >9)

The solution to be used was prepared by diluting 1 part of the alkaline product (#Ductile™) with 10 parts of water. The solution thus prepared was used as such, by spraying it on the surface of a fabric seat of a car to be washed and with various stains to be removed. Subsequently, the entire surface, on which the product had been applied, was brushed and the solution was left to act for approximately 10 minutes. Finally, the surface excess was removed with equipment that sucks up liquids, for example, traditional dry steam equipment or Mafra Geyser steam/suction units. The treated surface, once dried, presented inorganic stains that could not be removed with the alkaline product used and that were not clearly visible before the cleaning process.

1. A process for the cleaning and/or stain removal of plastic and fabric surfaces of vehicle interior parts, said process comprising:
dispensing an aqueous detergent composition having a pH comprised between 3 and 5 on an entire the surface to be treated;
brushing the entire surface treated with the composition;
waiting an average time comprised between 5 and 15 minutes;
optionally, dispensing an alkaline detergent composition on the same surface; and
removing from the of surface an excess with a damp cloth or a liquid suction equipment.

2. The process according to claim 1, wherein the aqueous detergent composition having a pH comprised between 3 and 5 comprises one or more of the following compounds in a total amount comprised between 0.01% and 0.5% by weight:
at least one inorganic acid;
at least one mono, di- or tri-carboxylic organic acid;
at least one phosphonic acid;
at least one hydroxyacid; or
at least one sulfonic acid.

3. The process according to claim 1, wherein the aqueous detergent composition having a pH comprised between 3 and 5 comprises one or more of the following compounds: citric acid, etidronic acid, glycolic acid and phosphoric acid.

4. The process according to claim 1, wherein the aqueous detergent composition having a pH comprised between 3 and 5 further comprised non-ionic surfactants, cationic surfactants, emulsifiers, sequestering agents, colorants and/or perfume.

5. The process according to claim 1, wherein the vehicles are selected from the group consisting of cars, motor vehicles, trucks, buses, railway carriages and public and private means of transport on rails.

6. The process according claim 1, carried out in manual, semi-automatic or automatic washing and drying systems.

7. The process according to claim 2, wherein
the at least one inorganic acid is phosphoric acid, hydrochlorid acid and/or sulfuric acid;
the at least one mono, di- or tri-carboxylic organic acid is acetic acid, citric acid, formic acid and/or oxalic acid;
the at least one phosphonic acid is etidronic acid;
the at least one hydroxyacid is glycolic acid and/or lactic acid; or
the at least one sulfonic acid is methanesulfonic and/or sulfamic acid.
